(19) United States
(12) Patent Application Publication
(10) Pub. No.: US 2018/0148027 A1
(43) Pub. Date: May 31, 2018

(54) DEVICE AND METHOD FOR OPERATING A MOTOR VEHICLE

(71) Applicant: Robert Bosch GmbH, Stuttgart (DE)

(72) Inventors: Berthold Fehrenbacher, Markgroeningen (DE); Peter Rebholz-Goldmann, Yokohama-Shi (JP); Peter Sautter, Lauffen (DE); Ruben Obenland, Grossbottwar (DE)

(21) Appl. No.: 15/576,378

(22) PCT Filed: Apr. 12, 2016
(86) PCT No.: PCT/EP2016/057973

§ 371 Date: Nov. 22, 2017

(30) Foreign Application Priority Data
May 26, 2015 (DE) 10 2015 209 565.7

(51) Int. Cl. B60T 8/88; B60T 8/172

(52) U.S. Cl. CPC B60T 8/885; B60T 8/172; B60T 2270/413; B60T 2270/416; B60T 2270/414

(57) ABSTRACT

A device for operating a motor vehicle, having an input for a respective external rotational speed sensor; a first control device; a second control device having a rotational speed acquisition device for each rotational speed sensor, a rotational speed signal of the rotational speed acquisition devices being capable of being supplied to the first control device and to outputs of the device; a computing device by which wheel rotational speeds can be ascertained; the rotational speed acquisition devices being functionally decoupled from one another; and the second control device being functionally decoupled from the first control device and from the computing device.

### FIELD

The present invention relates to a device and to a method for operating a motor vehicle.

### BACKGROUND INFORMATION

Generally, today's motor vehicles are equipped with one rotational speed sensor per wheel. Signals from the rotational speed sensors are evaluated in the brake control device (ABS/ESP, or similar control device), and are forwarded as needed to other control devices in the vehicle. The forwarding can take place either via bus or via a dedicated line. When certain possible errors of the brake control device are present, the forwarding of the wheel rotational speed information is not possible. In current motor vehicles, the driver must at all times be able to decelerate the motor vehicle by actuating the brake pedal.

In today's motor vehicles having an automatic parking brake, after the brake is tensioned there can be a loss of clamping force (for example due to relaxation of the brake pads). Therefore, tensioning first takes place with an increased clamping force, and second a control device follow-up takes place in which a post-tensioning of the brake pads is carried out. In this control device follow-up, a rolling away of the vehicle is recognized by reading in from the rotational speed sensors. This temporally limited follow-up drains the vehicle battery due to the control device operating current.

During automated driving, when there is a failure of the primary brake regulating system (ESP), a fallback level (for example using iBooster) has to take over the vehicle deceleration. This deceleration should be equipped with an antilocking device. For this purpose, wheel speed information is required. In order for this to be independent of the brake control device, additional wheel sensor signals are used.

### SUMMARY

An object of the present invention is to provide improved operation of a motor vehicle.

According to a first aspect of the present invention, a device for operating a motor vehicle is provided, the device having:
an input for each external rotational speed sensor;
a first control device;
a second control device having a rotational speed acquisition device for each rotational speed sensor, a signal of the rotational speed acquisition devices being capable of being supplied to the first control device and to outputs of the device;
a computing device by which wheel rotational speeds can be ascertained;
the rotational speed acquisition devices being functionally decoupled from one another; and
the second control device being functionally decoupled from the first control device and from the computing device.

Advantageously, in this way each individual channel of a rotational speed acquisition system can be made redundant and capable of waking. If the device is defective, wheel rotational speeds can still advantageously be available for other control devices that can be connected to the outputs of the device, for example for controlling a secondary brake system. This is achieved in that the rotational speed acquisition devices act as a kind of splitter that divide the rotational speed signals to a plurality of users. This advantageously brings about an independence and freedom of feedback effects of all the rotational speed channels.

According to a second aspect of the present invention, the object is achieved by a method for operating a motor vehicle having a device according to the present invention, having the steps:
reading in signals of rotational speed sensors via a rotational speed acquisition device for each wheel of the motor vehicle; and
supplying the read-in signals to the first control device and to outputs of the device.

On the basis of the waking capacity and redundancies thus achieved, it is then advantageously not necessary to install additional rotational speed sensors in the motor vehicle in order to obtain and further process valid rotational speed information in all circumstances.

Advantageous developments of the device and of the method are described herein.

In accordance with an advantageous development of the example device according to the present invention, each rotational speed acquisition device has a ground terminal. In this way, an independence and freedom from interference of the rotational speed acquisition devices is realized using an easily realized technical measure.

A further advantageous development of the present invention is distinguished in that the second control device is functionally decoupled from the computing device. This measure also supports the greatest possible degree of redundancy and independence of the rotational speed acquisition system. In particular, in this way it is possible for the computing device to be “awakened” or reactivated by the second control device when rotational speed signals are present.

A further advantageous development of the device is characterized in that the rotational speed sensors can be supplied with electrical power by an electrical voltage supply provided for the first control device, such that when there is a failure of the first control device the rotational speed sensors can be supplied with electrical power by an electrical voltage supply provided for the second control device. In this way, when there is a failure of the electrical main power supply an electrical voltage supply to the rotational speed sensors is enabled.

A further advantageous development of the device is distinguished in that a separate, independent ESD protection device is provided per rotational speed acquisition device. In this way, a common ESD protection is avoided, thus supporting the greatest possible freedom from electrostatic disturbance of the device.

A further advantageous development of the device is distinguished in that the rotational speed signal acquired by the rotational speed acquisition devices is supplied without feedback effects and independently both to the control device and to the external device. With a suitable technical realization, this facilitates a freedom from interference of the rotational speed signal that is passed through, the rotational speed signal having the best possible freedom from interference for the external control device.

In the following, the present invention is described in detail, with further features and advantages, on the basis of a plurality of figures. Here, all features form the subject matter of the present invention, independently of their representation in the description and in the figures. The figures are in particular intended to illustrate the main principles of the present invention. Identical or functionally identical elements have been provided with identical reference characters.

### BRIEF DESCRIPTION OF THE DRAWINGS

FIG. 1 shows a conventional device for operating a motor vehicle.

FIG. 2 shows a schematic diagram of a specific embodiment of a device for operating a motor vehicle.

FIG. 3 shows a schematic diagram of a rotational speed acquisition device.

FIG. 4 shows a schematic sequence of a specific embodiment of the method according to the present invention.

### DETAILED DESCRIPTION OF EXAMPLE EMBODIMENTS

In the following, a “functional decoupling” is to be understood as meaning that an individual error in a part or element does not have feedback effects on other parts or elements. For example, this can be understood as meaning that an electrical supply of power to a component is not dependent on an electrical supply of power to some other component.

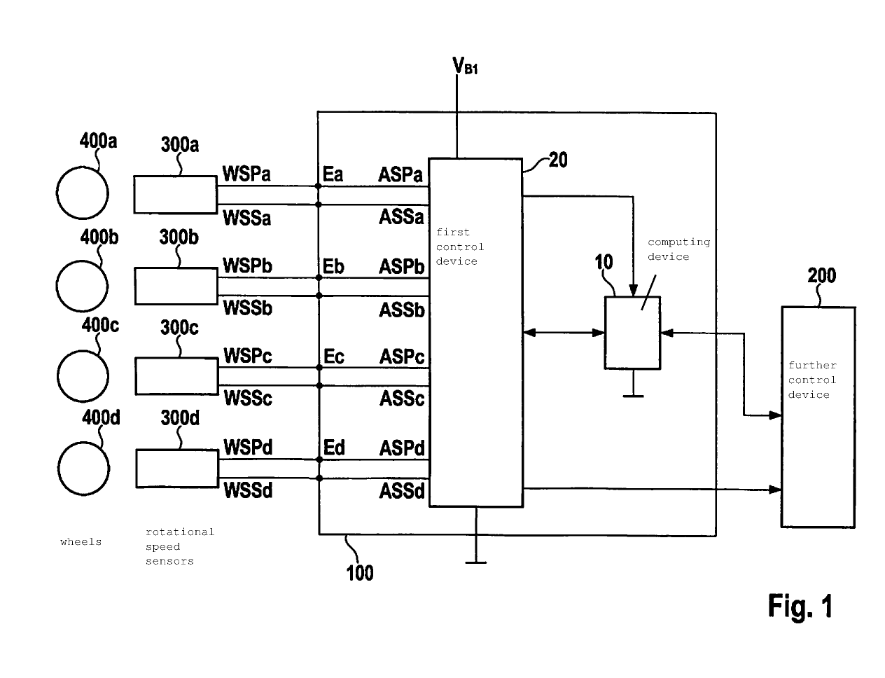

FIG. 1 shows a conventional device 100 for operating a motor vehicle (not shown). Device 100 includes a computing device 10 (for example a microcontroller, a microcomputer device, etc.) and a first control device 20 (for example an ASIC), the first control device 20 being connected to inputs Ea . . . Ed to which rotational speed sensors 300a . . . 300d, installed in wheels 400a . . . 400d of the motor vehicle, can be connected. Each of the rotational speed sensors 300a . . . 300d can read in a rotational speed from an associated wheel 400a . . . 400d of the motor vehicle. Rotational speed sensors 300a . . . 300d are supplied with electrical energy by electrical supply voltages WSPa . . . WSPd, or ASPa . . . ASPd. The read-in wheel rotational speed information is subsequently communicated to first control device 20. First control device 20 pre-processes the rotational speed information and then forwards it to computing device 10, which ascertains the wheel rotational speeds of wheels 400a . . . 400d, and, if warranted, forwards these speeds to other control devices (not shown) of the motor vehicle (e.g. via CAN bus).

If necessary, the rotational speed information is also communicated to a further device 200. For example, first device 100 can be fashioned as a control device (e.g. an ESP/ABS control device) of a primary brake system and device 200 can be fashioned as a control device of a secondary brake system of the motor vehicle. If device 100 fails, the rotational speed information is then disadvantageously also no longer available for the further control devices. Therefore, in this configuration it may be, disadvantageously, that when there is a failure of device 100 rotational speed information is not available for control device 200, which can cause a lasting disruption of a rotational speed-based controlling of functionalities.

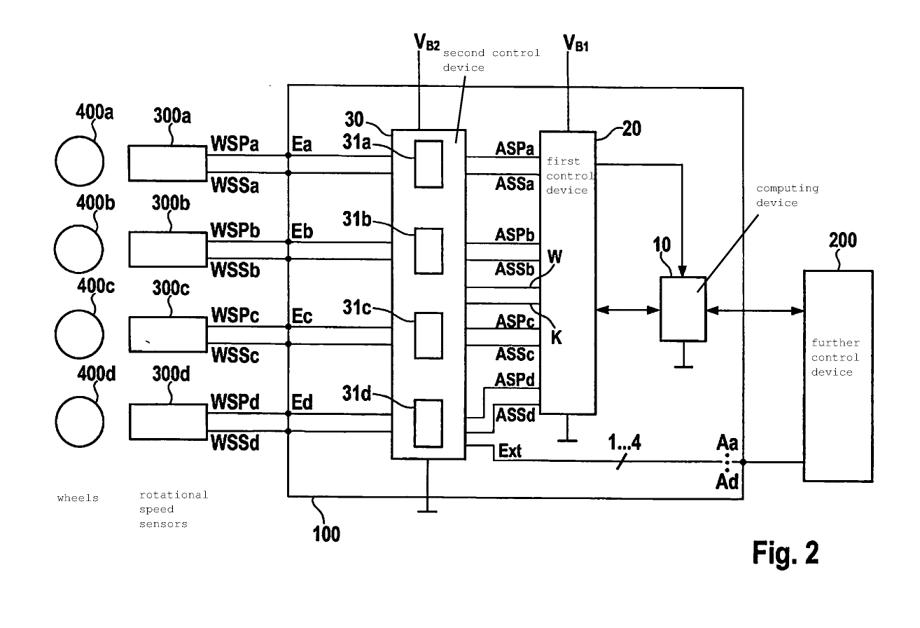

Therefore, in accordance with an example embodiment of the present invention, the system for acquiring the wheel rotational speeds as redundant as possible. For this purpose, as can be seen in FIG. 2, a second control device 30 (e.g., an ASIC) is to be provided that can be connected to rotational speed sensors 300a . . . 300d. If second control device 30 is no longer electrically supplied with power via first control device 20, an independent supply voltage VB2 is activated in order to supply electrical power to second control device 30 or to rotational speed sensors 300a . . . 300d. Second control device 30 has four rotational speed acquisition devices 31a . . . 31d, which can read in rotational speed information from rotational speed sensors 300a . . . 300d at inputs Ea . . . Ed. In addition, using second control device 30 it is possible to route the read-in rotational speed information of all wheels 400a . . . 400d to outputs Aa . . . Ad of device 100. In this way, it is possible to provide the rotational speed information to external control device 200, which is to be connected to terminals Aa . . . Ad, even when, for example, there is a failure of first control device 20 and/or computing device 10.

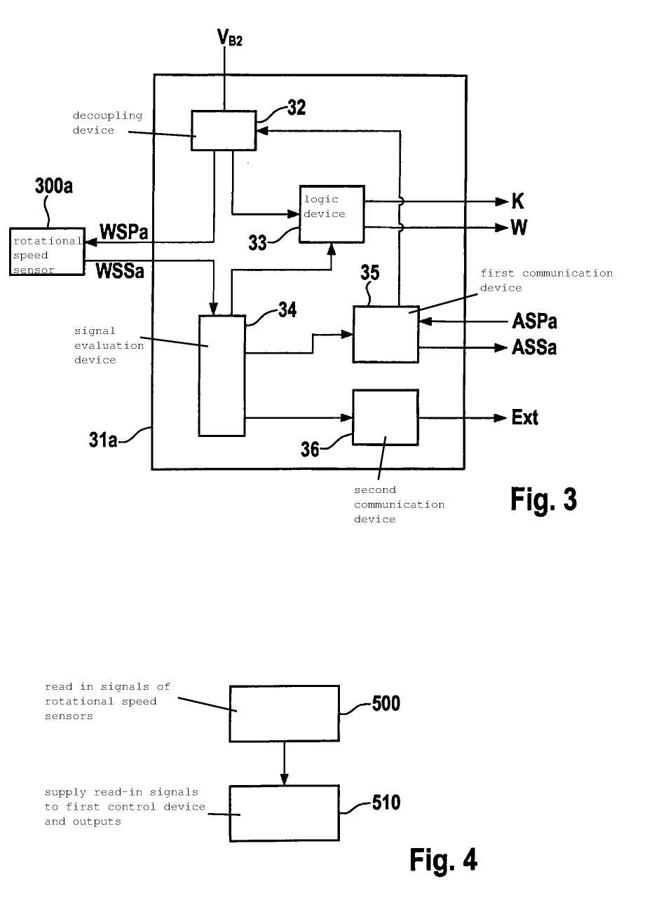

FIG. 3 shows a detailed schematic diagram of rotational speed acquisition device 31a. All of the rotational speed acquisition devices 31a . . . 31d are identical in design and function in the same manner. In normal operation, rotational speed sensor 300a is supplied with electrical voltage by a supply signal ASPa that is derived from supply voltage VB1. Rotational speed acquisition device 31a . . . 31d includes a decoupling device 32 for an electrical supply voltage that ensures that rotational speed sensor 300a is supplied with electrical power by supply voltage VB2 in case first control device 20 fails. Decoupling device 32 can for example be realized by two suitably connected diodes.

In addition, rotational speed acquisition device 31a . . . 31d includes a logic device 33 that sends a wake signal W to first control device 20, and communicates with computing device 10 via a communication line K. Wake signal W is generated and sent when, in standby operation of device 100, a rotational speed signal is acquired that is communicated to first control device 20, which then initiates a further processing.

A signal evaluation device 34 is provided in order to communicate a sensor signal WSSa of rotational speed sensor 300a to a first communication device 35 and to a second communication device 36. First communication device 35 is provided to communicate sensor signal WSSa internally to first control device 20. Second communication device 36 is provided to conduct rotational speed signal WSSa to output Aa of device 100. The rotational speed signal sent to output Aa is preferably realized as a voltage level signal. When there is an error in one of the rotational speed channels, in this way no coupling to the other rotational speed channels takes place. Thus, a complete redundancy of each of the individual rotational speed acquisition devices 31a . . . 31d is achieved, so that interference in one of the rotational speed channels does not have an effect on the other rotational speed channels. In this way, a freedom from feedback effects of the individual rotational speed channels is advantageously supported.

Preferably, each individual rotational speed acquisition device 31a . . . 31d has its own ground pin. In addition, the lines via which the rotational speed signals are distributed are preferably each provided with their own ESD protection against electrostatic discharge.

In this way, a highly available item of wheel rotational speed information can be provided through a decoupling of the four rotational speed signals. Here, possible sources of error in the voltage supply and also sources of error in first control device 20 can be taken into account that could have a feedback effect on the other channels. In addition, in this way a recognition of individual errors is possible, for the purposes of warning the driver and graceful degradation of the system.

Advantageously, the wake capacity based on rotational speed acquisition can for example be used for an electric parking brake of the motor vehicle, if for example it is determined that the vehicle is rolling away from a standstill, when all the electronic control devices are normally deactivated. Due to the wake capacity of rotational speed acquisition devices 31a . . . 31d, the rotational speed signal can now be communicated, internally to the device (device 100), to first control device 20 or to the externally connectable control device (device 200). Using the rotational speed information provided in this way, for example a mechanical post-tensioning of the electric parking brake can be initiated. This can be a significant improvement compared to conventional parking brake strategies that provide a time-based re-tensioning of the parking brake, possibly based on a degree of incline of a parking space.

The decoupling of the primary brake system (ABS/ESP) from an associated secondary brake system controlled by external device 200 can be realized either by user-specific semiconductor circuits or by discretely realized circuits.

The wake capacity and the wheel rotational speed type selection can be configured by a communication line K. Here, both an intermittent monitoring, which advantageously results in a reduced power consumption of rotational speed sensors 300a . . . 300d, and a permanent monitoring of individual rotational speed sensor channels are possible. The following realizations are possible:

a) permanent monitoring of a defined number of rotational speed sensors 300a . . . 300d;

b) rotating monitoring of a plurality of rotational speed sensors 300a . . . 300d;

c) intermittent monitoring of a defined number of rotational speed sensors 300a . . . 300d;

d) a combination of b) and c).

The configuration that can be modified in a correctly functioning system is maintained as long as an electrical voltage supply is available at second control device 30. It is also possible to store the configuration in a nonvolatile memory (not shown).

For second control device 30, the following states are possible:

### Normal Operation of Device 100 (e.g., in an Automated Driving Mode)

In this case, a supply of electricity to rotational speed sensors 300a . . . 300d takes place via redundantly generated supply voltages, for example via the signals ASPa . . . ASPd, a configuration or modification of the configuration (e.g. duration of monitoring of the wheels, which wheels are monitored, etc.) of second control device 30 being possible via a communication interface (e.g. SPI interface). An outputting of the rotational speed signals of rotational speed sensors 300a . . . 300d here takes place for an internal and for an external use, the internal signals being decoupled from the external signals. In this case, a signal path can be tested for errors, for example when device 100 is started up.

### Device 100 in Standby Operation

In this case, an electrical supplying of rotational speed sensors 300a . . . 300d also takes place via independent electrical supply voltage VB2, computing device 10 and first control device 20 being deactivated in this case. As a function of a configuration, rotational speed sensors 300a . . . 300d are monitored for rotational speed in order to generate a wake pulse. If a wheel rotational speed is recognized, an activation of the outputs takes place, device 100 being reactivated by wake signal W. This scenario can advantageously be used in a parking situation, whereby the electric parking brake is automatically re-tensioned when the vehicle begins to roll away.

### An Error in Device 100

In this case as well, rotational speed sensors 300a . . . 300d are supplied with electricity via supply voltage VB2. An output of the rotational speed signals for the external use is decoupled from the device-internal use. A forwarding of the internal rotational speed signals may indeed take place, but under some circumstances these signals are not further processed due to the defect of computing device 10, first control device 20, etc.

### Defect in Rotational Speed Sensor 300a . . . 300d

In this case, in a defect of the wheel rotational speed sensor system the other rotational speed sensors are not influenced, and the discovery of the error takes place in device 100. Already today, such a rotational speed acquisition system must be able to realize a suitable strategy even when only three rotational speed channels are operational.

With the present invention, it is advantageously possible to increase the availability of the wheel rotational speed information in the vehicle, and a wheel rotational speed can also be used as a wake source for control devices in order to prevent the vehicle from rolling away after it has been parked. In this way, for example the electrical load on the vehicle battery in the named control device follow-up can also be advantageously reduced, because a permanent electrical supply is required only to rotational speed sensors 300a . . . 300d.

The method advantageously makes it possible to increase the availability of the wheel rotational speed information without having to install additional rotational speed sensors. In addition, the method can be realized with conventional rotational speed sensors.

The recognized loss of an individual wheel rotational speed is taken as acceptable. A feedback or interaction effect between the individual rotational speed channels can advantageously be avoided.

FIG. 4 shows a schematic flow of a specific embodiment of the method according to the present invention.

In a step 500, a reading in of signals of rotational speed sensors 300a . . . 300d is carried out for each wheel of the motor vehicle by a rotational speed acquisition device 31a . . . 31d.

In a step 510, the read-in signals are supplied to first control device 20 and to outputs Aa . . . Ad of device 100.

In a development of the method and of the device in accordance with the present invention, it would also be possible to provide the recognition of redundant speed signals from other signals, for example from camera signals and/or from signals of acceleration sensors of the motor vehicle.

In a development in accordance with the present invention, it would also be possible for the described wake capacity of the rotational speed acquisition system, which is provided by second control device 30, to be provided by rotational speed sensors 300a . . . 300d.

In a development in accordance with the present invention, it would also be possible for the wake capacity of the rotational speed acquisition system to be provided by a magnetic induction of passive wheel rotational speed sensors.

In a development in accordance with the present invention, it would also be possible for the rotational speed information to be forwarded to device 200 not by channel-individual lines, but by data bus.

The present invention advantageously enables a highly automated driving, in which the wheel rotational speed information can be supplied to a further control device, which then controls the braking processes, even when there is a failure of the ABS/ESP system.

In sum, the present invention provides a device and a method for operating a motor vehicle with which a highly available rotational speed acquisition, including wake capacity, is provided. Due to the fact that the functionality of the rotational speed acquisition devices is redundant and independent of a functionality of device 100, in every case a wheel rotational speed can also be communicated to a further control device and used by this device. Due to the fact that the individual rotational speed acquisition channels are redundant and free of feedback effects among one another, a maximum degree of functionality can be provided even given a reduced number of rotational speed acquisition devices.

Although the present invention has been described above on the basis of concrete exemplary embodiments, it is in no way limited thereto. The person skilled in the art will thus also realize specific embodiments that are not expressly described above, or are described only partially above, without departing from the core of the present invention.

1-10. (canceled)

11. A device for operating a motor vehicle, comprising:
an input for each respective external rotational speed sensor;
a first control device;
a second control device having a rotational speed acquisition device for each rotational speed sensor, a rotational speed signal of the rotational speed acquisition devices being supplied to the first control device and to outputs of the device; and
a computing device by which wheel rotational speeds are ascertained;
wherein the rotational speed acquisition devices are functionally decoupled from one another; and
wherein the second control device is functionally decoupled from the first control device and from the computing device.

12. The device as recited in claim 11, wherein each rotational speed acquisition device has a ground terminal.

13. The device as recited in claim 11, wherein the second control device is functionally decoupled from the computing device.

14. The device as recited in claim 11, wherein the rotational speed sensors are supplied with electricity by an electrical voltage supply provided for the first control device, the rotational speed sensors being capable of being supplied with electricity by an electrical supply voltage provided for the second control device when there is a failure of the first control device.

15. The device as recited in claim 11, wherein a separate, independent ESD protection is provided per rotational speed acquisition device.

16. The device as recited in claim 11, wherein the rotational speed signal acquired by the rotational speed acquisition devices is supplied both to the control device and to the external device free of feedback effects and independently.

17. A method for operating a motor vehicle using a device including an input for each respective external rotational speed sensor, a first control device, a second control device having a rotational speed acquisition device for each rotational speed sensor, a rotational speed signal of the rotational speed acquisition devices being supplied to the first control device and to outputs of the device, and a computing device by which wheel rotational speeds are ascertained, wherein the rotational speed acquisition devices are functionally decoupled from one another, and wherein the second control device is functionally decoupled from the first control device and from the computing device, the method comprising:
reading in signals from the rotational speed sensors using a rotational speed acquisition device for each wheel of the motor vehicle; and
supplying the read-in signals to the first control device and to the outputs of the device.

18. The method as recited in claim 17, wherein a voltage supply to the rotational speed sensors is taken over by a redundantly generated electrical supply voltage when there is a failure of an electrical supply voltage.

19. The method as recited in claim 17, wherein a wake signal is sent to the first control device when a rotational speed signal is read in from the second control device, when the first control device is deactivated.

20. A non-transitory computer-readable data carrier on which is stored a computer program product having program code for operating a motor vehicle using a device including an input for each respective external rotational speed sensor, a first control device, a second control device having a rotational speed acquisition device for each rotational speed sensor, a rotational speed signal of the rotational speed acquisition devices being supplied to the first control device and to outputs of the device, and a computing device by which wheel rotational speeds are ascertained, wherein the rotational speed acquisition devices are functionally decoupled from one another, and wherein the second control device is functionally decoupled from the first control device and from the computing device, the computer program, when executed by a computing device, causing the computing device to perform:
reading in signals from the rotational speed sensors using a rotational speed acquisition device for each wheel of the motor vehicle; and
supplying the read-in signals to the first control device and to the outputs of the device.
